(19) United States
(12) Patent Application Publication
(10) Pub. No.: US 2015/0057783 A1
(43) Pub. Date: Feb. 26, 2015

(54) Manufacturing and Asset Maintenance

(71) Applicant: Sergio Javier Rossi, Mansfield, TX (US)

(72) Inventor: Sergio Javier Rossi, Mansfield, TX (US)

(21) Appl. No.: 13/975,199

(22) Filed: Aug. 23, 2013

(51) Int. Cl. G05B 19/418

(52) U.S. Cl. CPC G05B 19/41875
USPC 700/108

(57) ABSTRACT

Processes, a methodology and software are provided for improving manufacturing and asset maintenance in machine intensive environments such as manufacturing, processing, assembly plants and military. In particular, for improving assets reliability, performance and maintenance. A process includes developing an asset plan to improve machinery reliability, performance and maintenance and a business plan to measure revenues, profits and market share gained through the activities generated by said asset plan implemented in a short amount of time. A method for dividing a manufacturing system into elements to simplify, for identifying and prioritizing sources of stress and for solving and managing said solutions. A method for forming matrices of interacting elements for solving or reducing said sources of stress in a short amount of time. A software for calculating ROI and for providing business information as well as the condition of the assets.

### BACKGROUND OF THE INVENTION

The present invention relates to processes, a method and software for improving manufacturing and asset maintenance, specifically to processes, methods and software for improving reliability, maintenance and performance functions used in manufacturing, processing and assembly plants as well as other systems which heavily depend on machinery and maintenance performance such as the military.

### Problems

Existing CIP Reducing manufacturing efficiencies has been approached in a very segmented manner which resulted in many areas of conflict and misunderstanding, in particular when it comes to RPM . . . firefighting mode??? One problem at a time . . . never looking at it using a systematic approach?

RCA root cause analysis is based on historical data . . . nowadays, technology allows us to use tools that can find the source of failure before it becomes a failure. There must be a shift from analyzing breakdowns based on past failure to avoiding failures by focusing efforts on eliminating the sources of stress which originally causes failures

Diluted Efforts (List of Task that are not Tied Together . . . )

no plan for bringing mfg & mice together

Business objectives and maintenance plans are not necessarily integrated in a meaningful or synergistic way

As result, RPM efforts are not well funded

develop tools owners can use to cut the fat without cutting the meat and the bone . . . a business plan is such a tool because they can relate to it and it will provide a sense of feedback from their investment in RPM

There are no standard means to measure the ROI of benefits from CIP or RPM tools and as result, it is hard to sustain them long term

Owners don't understand how RPM processes can positively affect RPMs/ROI

As result, RPM efforts are not sustained long term

### Slow CIP

CIP's don't easily apply to machinery and maintenance

### Unsustained CIP

Confusion as to what maintenance tool to use to improve revenues, profits or market share (manufacturing equity)

There are no processes for introducing, implementing or improving reliability, performance and maintenance (RPM)

### Consequence

A systematic approach to RPM is needed

RCA is a patching approach

No direction, POM, cyclic efforts wear down everyone

A means to calculate a ROI everyone can agree to and follow is needed.

It is very important to provide ROI in a fast manner to obtain support from owners and to show them a good investment

### Problems

Complex systems to improve due to the large number of components and different variables and interacting parameters. A diverse culture, processes with many variables and sophisticated machinery pushed to maximize output are combined into a unique combination/mix . . . .

Say that it is difficult to simplify and sometimes the obvious is not seen or understood it is difficult to keep focus, support and sustain long term as objectives and logros sometimes are misrepresented and now well explained . . . blah

While human performance is credited with causing 80-90% of failures according to various sources, including the DoD, there is no solution for reducing human factor losses Diverse culture resulting from owners, operators and maintainers having different backgrounds and interests

No common objectives between OOM. Conflict of interest are hard to resolve as operators need to run machines to reach production quota while maintainers need machines down for performing maintenance tasks

The operators operate and maintainers maintain approach to manufacturing is still present today

There are no tools for owners to understand the needs of maintainers and there is no transparency of how maintenance affects the bottom line

Most operators and maintainers don't understand how RPM processes can positively affect RPMs

It is easy to lose sense of what is important when dealing with problems of complex structures like mfg.

### Consequence

A method for simplifying complex systems such as manufacturing is needed before improving said systems.

A holistic approach to manufacturing is needed to bring owners, operators and maintainers together

No synergy, little cooperation

A high level approach to see manufacturing as a system is necessary to better invest

### BRIEF SUMMARY OF THE INVENTION

It is, therefore, an object of the present invention to provide a solution for improving manufacturing and asset maintenance by providing processes, a method and software for improving reliability, maintenance and performance while increasing revenues, profits and market share.

These processes for improving manufacturing and asset maintenance includes:

1) Developing a process for improving manufacturing/asset maintenance
2) Developing a business plan for owners
3) Developing a Asset Plan for providing a ROI in a short amount of time
4) Developing a business plan for owners to improve RPM
5) Developing a business plan for Operators & Maintainers to improve RPM
6) Calculating a ROI from RPM activities
7) Providing a Feedback Loop for improving manufacturing and asset maintenance plan
8) Developing a methodology for solving complex problems while providing a ROI in a short amount of time
9) Building a Table for Managing Elements of a complex systems
10) Using a Table of elements for Identifying Sources of Stress
11) Developing a table of elements for prioritizing sources of stress
12) Developing Layers/Levels using a Table of Elements for Machines

### BRIEF DESCRIPTION OF THE SEVERAL VIEWS OF THE DRAWINGS

FIG. 1) A process for improving manufacturing and asset maintenance

FIG. 2) A process for developing a business plan for owners

FIG. 3) A process for developing a asset plan for providing a ROI in a short amount of time

FIG. 4) A process for developing a business plan for owners to improve RPM

FIG. 5) A process for developing a business plan for Operators & Maintainers to improve RPM

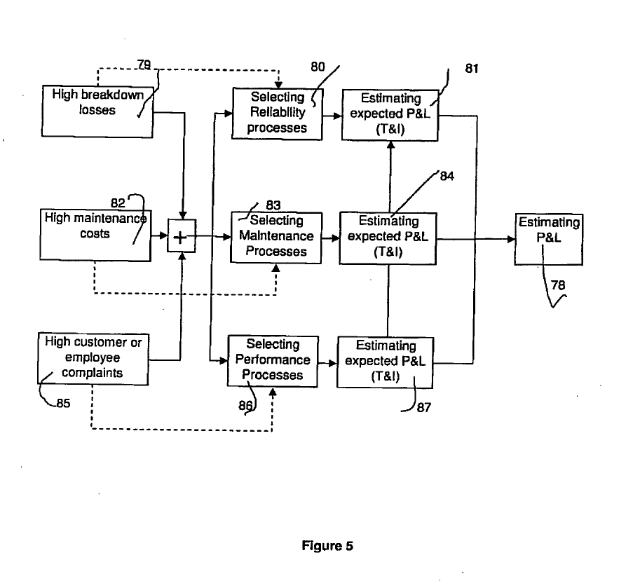

FIG. 6) A process for calculating a ROI from RPM processes

FIG. 7) A process for providing a feedback loop for improving manufacturing and asset maintenance plan

FIG. 8) A process for developing a methodology for solving complex problems while providing a ROI in a short amount of time

FIG. 9) A process for building a table for managing elements of a complex systems

FIG. 10) A process for using a table of elements for identifying sources of stress

FIG. 11) A process for developing a table of elements for prioritizing sources of stress

FIG. 12) Generating layers or levels using a table of elements for machines

FIG. 13) Generating a sub level using a table of elements for machines

FIG. 14) Generating another sub level using a table of elements for machines

### 1) Developing a Process for Improving Manufacturing and Asset Maintenance

### Problem:

No solution to further improve manufacturing and maintenance performance. Without a plan owners can understand and support, O&M will not obtain adequate resources for implementing or improving RPM

Continuous Improvement Processes (CIP) which have helped operations efficiencies by making production less wastefull using a Lean approach, improve throughput using the Theory of Constraints and reduce variances using Six Sigma tools.

Total Productive Maintenance (originated in the 1960's) have introduce a framework which has helped improve maintenance using tools such as operator based maintenance, introducing small changes (Kaizen) and a few other helpful tools.

While TPM is based on 8 pillars that supposedly provide a structure, each of the pillars is really a stand alone unit with little or no interaction with the other pillars. These pillars are: Focused improvement, planned maintenance, initial control, education and training, autonomous maintenance, quality maintenance, office TPM and Safety, hygiene and environment. Overall Equipment Effectiveness (OEE) is used to trend progress. There are software packages called Computerized Maintenance Management Systems (CMMS). There are technologies used to assess the condition of machinery and predict their failures. These technologies, known as predictive maintenance, can provide good results when they are properly funded, supported and sustained over time by owners, operators and maintainers. As CMMS and PdM take too long to generate a ROI, they tend to be sidelined and not used to generate benefits. All these improvement processes and tools are effective if adequately used and supported. What they miss is a plan that gives owners, operators and maintainers a direction on how to integrate them and better utilize them. Without a plan that shows owners the great ROI these processes and tools provide in the short and long term, owners will not adequately funds these efforts and sustain solutions that don't show a ROI. It is imperative to develop a business plan owners can use to better understand, trend and see where the ROI in reliability, performance and maintenance is coming from.

It is an objective of this patent to present a high level plan owners, operators and maintainers can understand, adequately support and sustain long term.

### Solution:

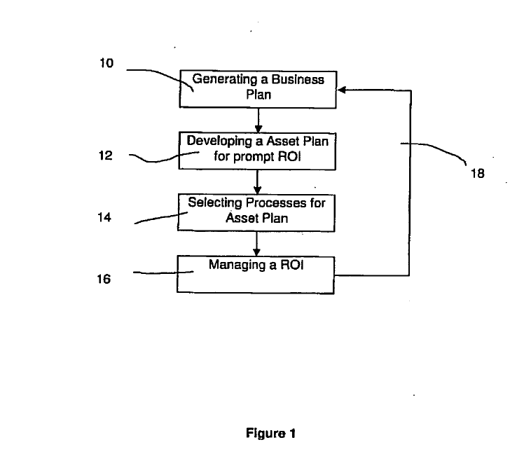

FIG. 1 shows a plan owners, operators and maintainers can use to improve manufacturing and asset maintenance.

The process shown on FIG. 1 consist of a process for generating a business plan (10), a process for developing a asset plan that can provide a prompt ROI (12), a process for selecting best processes for a asset plan (14), a process for managing a ROI (16) and a process for generating a feedback loop (18) back to the business plan.

### 2) Developing a Business Plan for Owners

Owners see maintenance as a cost center. There is no business plan for owners to see manufacturing and maintenance as a business opportunity. Most owners of manufacturing plants background is finance. While they understand the financial side of manufacturing, they typically do not see nor understand the needs of asset maintenance. The economical consequences of asset maintenance are misunderstood and not adequately measured.

O the other hand, operators and maintainers background is either operations or maintenance and unless they are responsible for the entire plant (as plant managers typically do) they seldom have a good understanding of the economical needs of the plant. Developing a business plan will provide operators and maintainers a tool they can use to present owners a more accurate and detailed picture of their needs as well as the ROI of asset maintenance can provide if owners provide enough funds to start and sustain those efforts.

It is an objective of this patent to show owners, operators and maintainers a way they can use to support and sustain maintenance improvement processes.

### Solution:

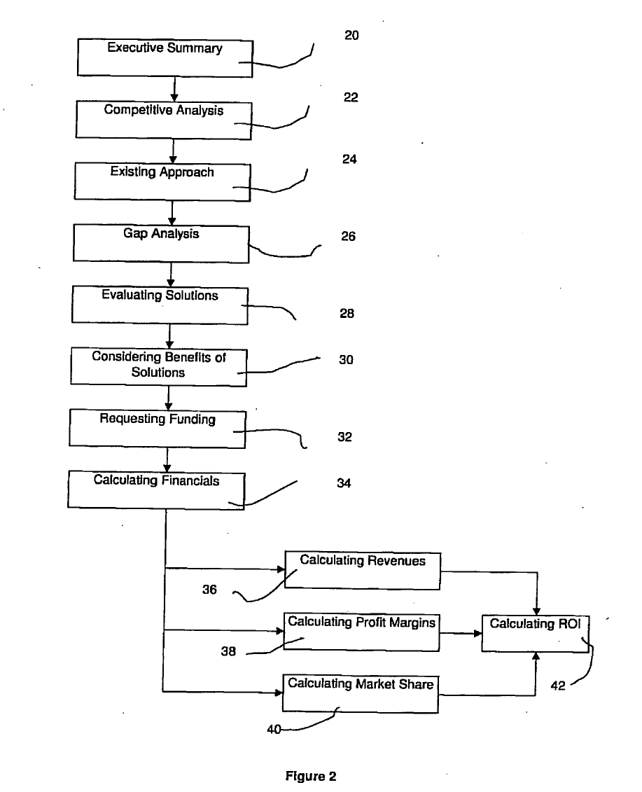

FIG. 2 shows a process that steps typical of business plans, to include evaluation of existing approaches and options available to increase revenues, profits and market share and calculating the ROI from reliability, performance and maintenance processes.

FIG. 2 shows a business plan (10) consisting of an executive summary (20) to inform owners of the benefits of implementing processes for increasing revenues, profits and market share. A high level summary of the maintenance needs to improve and the expected ROI, a competitive analysis (22) to analyze what other manufacturing plants are doing in reference to asset maintenance processes and tools that they have in place, in progress or lacking. This is typically accomplished by attending seminars, conferences or reading articles in magazines or books. Existing approach (24) for determining what is the current method for maintaining machinery (whether it is reactive, time based or world class maintenance). A gap analysis (26) or assessment is to determine the gap between existing processes already in place and those processes that are deemed necessary for further optimizing maintenance. Evaluating Continuous Improvement Processes (CIPs) solutions (28) applicability by assessing machinery, processes in place and culture adaptability to new efforts. CIPs benefits (30) to determine if the benefits that processes for improving maintenance can provide and how beneficial those can be in reducing breakdowns, maintenance costs and production losses. Funding request (32) is for submitting a request to obtain funds to implement selected maintenance processes. Calculating Financials (34) is a step needed for assessing revenues, profits and market share that could result from implementing maintenance processes. Calculating Revenues (36), Calculating Profit margins (38) considering past losses caused by maintenance processes as well as profits obtained from reliability and performance processes, Calculating Market Share (40) considering internal and external customers and Calculating ROI (42) for generating four particular aspects of financial metrics.

### 3) Developing a Asset Plan for Providing a ROI in a Short Amount of Time

Existing CIP solutions take long to produce a ROI because they tend to be a combination of various CIP (TPM, Lean, Six Sigma, etc.) with some technologies (vibration, infrared, etc.). This approach consists of a list of activities that can not be easily coordinated. There are no cohesive and comprehensive plans for improving assets performance in a short amount of time.

It is an objective of this patent to combine a method with processes for developing an asset plan for owners, operators and maintainers.

### Solution:

Once owners, operators and maintainers determined that ROI is significant, then a asset plan follows to obtain those benefits. The asset plan consists of a methodology for generating a fast implementation of processes to obtain a fast ROI.

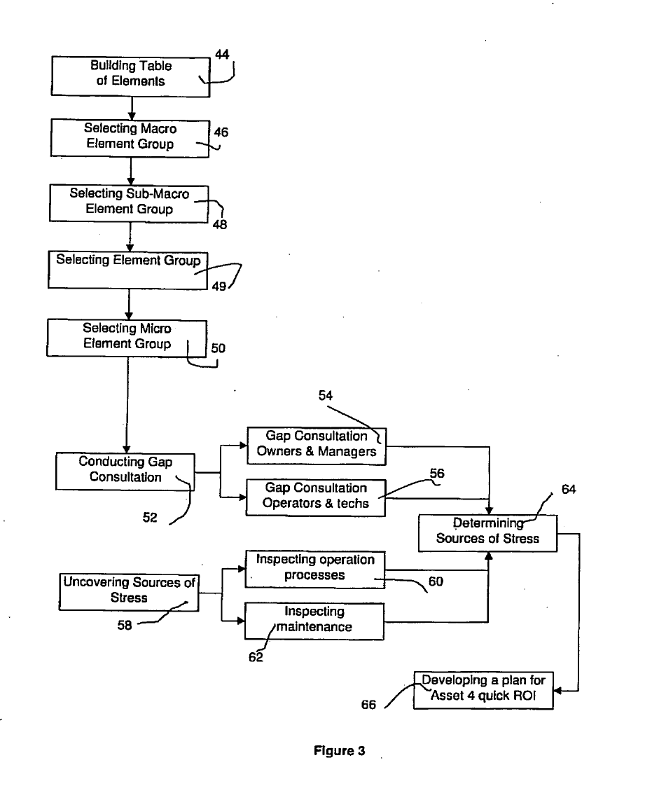

FIG. 3 shows a method for building table of elements (44) containing all of the system's elements, a process for selecting group containing macro elements (46), a group containing sub-macro element (58), a group containing elements (49) and a group containing micro element (50). Once the corresponding groups are determined, then it is easier to perform a high level gap consultation at both levels simultaneously, macro and micro-element level (52), Conducting gap consultation by interviewing owners and managers using macro element group (54) table and conducting gap consultation by interviewing operators and technicians using micro-element group (56) table, This approach will make it easy for uncovering sources of stress (58) of machines and processes. Economical and physical stresses are considered. Inspecting operation processes to find sources of stress (60) in production areas that can affect an asset maintenance. Inspecting maintenance processes to find sources of stress (62). For example, it is necessary to determine whether reactive, preventive or predictive types of maintenance are performed. Determine sources of stress found at macro-element level (64) obtained from interviewing owners, operators and maintainers and from inspecting processes for operations and maintenance. Finally, developing a plan for converting sources of stress into stress targets using a table of elements methodology (66) to determine which elements are to be prioritized.

### 4) Developing a Business Plan for Owners to Improve Asset Maintenance

There are no high level plans owners can use for improving assets RPM. The direct relationship between revenues, profits and market share (RPMs) with reliability, performance and maintenance (RPM) processes is not well understood, hence, these processes are seldom implemented by direct order of owners. While these three processes could be implemented simultaneously to produce a faster and better ROI, this seldom happens because their relationship and implementation seems at times conflictive.

It is an objective of this patent to show how the direct relationship between “Revenues, Profits and Market Share (RPMs)” with “Reliability, Performance and Maintenance (RPM) processes” to help owners direct their implementation.

### Solution:

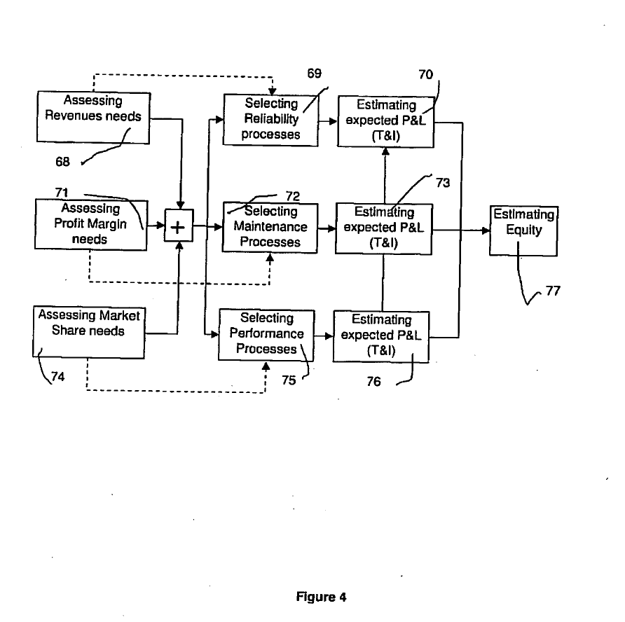

FIG. 4 shows a process for determining which improvement processes for reliability, performance or maintenance will provide the best ROI when the request or interest for improvement came from owners

For example, if a manufacturing plant is 100% sold, then it is important to continue satisfying customer demand. A plant can supply products by implementing or improving reliability processes.

On the other hand, if a plant has over capacity but owner gets product returned due to quality issues tracked back to machinery not maintained well, then in this case, focusing efforts on improving maintenance process may provide owners a faster ROI than investing in reliability or performance improvement processes.

In addition, this process unifies owners with operators and maintainers as they can better understand how reliability, performance and maintenance activities are directly linked to revenues, profits and market share. If owners decide to cut costs because of an economical downturn, then they will know the consequences and could better prepare themselve to reduce future damage.

Plans for improving manufacturing can either start at a plant level or owners level (typically at corporate level).

When they are started at a plant level, CIP can be selected without really considering the economical needs of a plant.

Market share considers both, internal and external customer service. For internal customer services, working conditions, employee turn over are considered. For external customer services, returns and on-time delivery are major parameters to consider.

A plan for owners to increase manufacturing RPMs is shown on FIG. 4. Needs for revenues is assessed (68), needs for profit margins is assessed (71), needs for increasing market share is assessed (68) and compared to find out which one is the most critical and important for providing a fast ROI. Then reliability, performance and maintenance processes can be selected accordingly.

Performing a gap consultation (54) & (56) may or may not be necessary.

Revenue needs are assessed (68) and then if determined to be the most important, reliability processes (69) are selected. The expected tangible and intangible profit and losses are estimated (70).

Profit margin needs are assessed (71) and then if determined to be the most important, maintenance processes (72) are selected. The expected tangible and intangible profit and losses are estimated (73).

Market share needs are assessed (74) and then if determined to be the most important, performance processes (75) are selected. The expected tangible and intangible profit and lasses are estimated (76).

Estimating equity results from adding the total possible value obtained from adding revenues, profits and market share resulting from the processes that was selected to provide owners with the fastest P&L (77).

Equity is the estimated value that owners can consider to estimate the value gained from selecting reliability, performance and maintenance processes

Once the equity is estimated, then a asset plan can be developed and implemented using the details previously explained (66)

### 5) Developing a Business Plan for Operators & Maintainers to Improve RPM

### Problem:

there is no business plans operators and maintainers can use for improving assets maintenance while considering the economical impact.

It is an objective of this patent to generate a process operators and maintainers can use for reducing losses using RPM processes.

### Solution:

A process is needed for determining which improvement processes for reliability, performance or maintenance will provide the best ROI when the request or interest for improvement arrives from plant management.

For example, if a manufacturing plant has high levels of downtime (or reactive maintenance) but the final product quality is good and customer demands are fulfilled, then it is important to introduce or improve reliability processes to produce a fast ROI.

On the other hand, if a plant has over capacity and good quality but has a high turn over ratio, then in this case, focusing efforts on improving performance processes such as training or involving operators to do some maintenance may provide a faster ROI than investing in reliability or maintenance processes.

If assets breakdown losses (or downtime percentage) (79) is highest, it is determined to be the most important, then reliability processes (80) are selected. The expected tangible and intangible profit and losses are estimated (81).

If maintenance costs are assessed (82) is highest, it is determined to be the most important, then maintenance processes (83) are selected. The expected tangible and intangible profit and losses are estimated (84). Maintenance costs can be obtained from the actual maintenance budget and may or may not include production losses caused by breakdowns.

If customer and/or employee complaints (85) is highest, it is determined to be the most important, then performance processes (86) are selected for improving human and process performance. The expected tangible and intangible profit and losses are estimated (87).

The total estimated P&L from each process is estimated (78) and used for implementing a asset plan (66) for providing the fastest ROI.

6) Calculating a ROI from RPM Activities

### Problem:

there are no standard means for calculating ROI from CIP's. Sometimes, benefits obtained from implementing CIP's tend to be exaggerated and as result, trust is lost in maintenance or manufacturing to produce a ROI or improve P&L. Sometimes, they are not calculated at all and as result, when there is a need to cut costs, those CIP's are the first ones to be stopped. Some plants measure Overall Equipment Effectiveness (OEE) but it is a very generic parameter that can not be related to ROI.

Whether the need for developing a asset plan came from a business plan or from owners, operators or maintainers, the economical benefits from their implementation must be calculated as accurately as possible. While this is not a simple task, due to the large number of variables this system possesses, it must be done.

It is an objective of this patent to provide a process for calculating ROI directly from RPM activities.

### Solution:

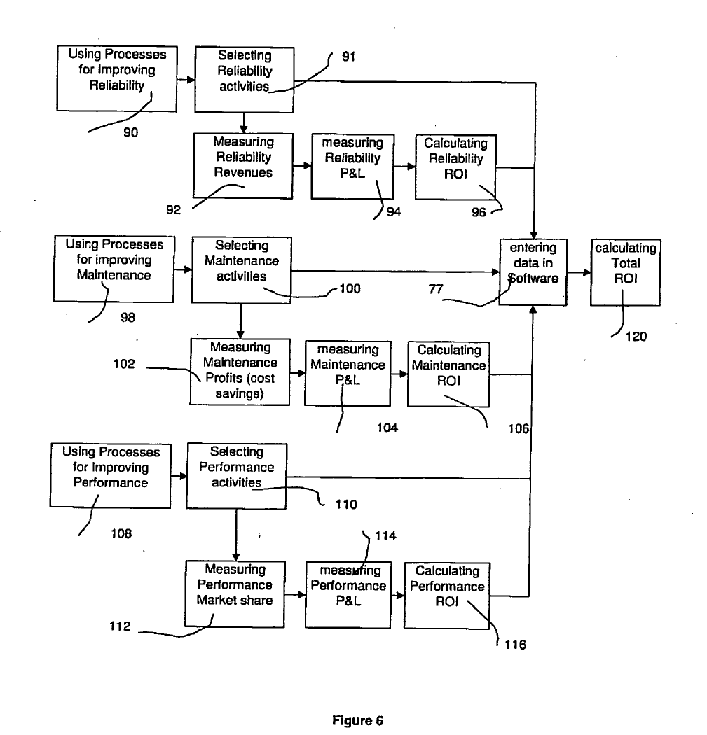

FIG. 6 shows how the final ROI is obtained from each of the improvement processes selected for increasing revenues, profits and market share.

Once a process or processes for improving reliability were selected (90), then each of the activities that pertain to those processes (91) must be listed for implementing. This can be done by generating and using a table of elements pertaining to each of the processes and choosing the ones which will provide the fastest ROI according to table of priorities (151).

From the activities selected for the reliability processes (91), the resulting revenues it generated must be measured (92). This can be done, for example, by measuring a repair that was done under planning and scheduling activities directly resulting from reliability activities (91) such as vibration analysis. Revenues are divided into profits and losses (94) to consider both, the profits generated as well as losses avoided. This division provides a more realistic number that includes benefits that can not be identified in dollars. For example, reducing the risks of environmental losses. Profits are considered when a new apparatus is modified (like by adding sensor) is added to further improve reliability and thus generating profits that were not produced before the modification was made.

The reliability ROI (96) is calculated by dividing the quantified profits obtained and losses avoided (94) by the investment made. For example, hiring third party vibration services to determine the condition of bearings or a misalignment condition or the purchase of that sensor that was added.

The data is entered in software, which could be either CMMS or a software described in patent number U.S. Pat. No. 8,170,893, Sergio Rossi. The software calculates the total ROI (120) using data entered for each of the reliability, performance and maintenance processes.

The same process is repeated when processes for improving maintenance (98) or processes for improving performance (108) are chosen.

### 7) Providing a Feedback Loop for Improving Manufacturing and Asset Maintenance Plan

There are no means for providing ROI feedback from CIP's and to correct economical forecasting from RPM activities/plan

It is an objective of this patent to provide a feedback that can be used for controlling the benefits of a CIP for increasing RPMs.

### Solution:

During the development of a business plan (10) a ROI was calculated (42) During the development of the asset plan (12) for owners equity (77) was estimated, and for Operators and maintainers P&L was estimated (78) and during the implementation of RPM processes, P&L was actually measured (94) for each process. It is important that these three values get compared so that adjustments can be made. For example, a consultant may have been hired to implement RPM processes and he or she calculated and estimated values that did not come close to those measured. In addition, it is important to know what parameters have been left out and need to be added and which other parameters need to be removed. Software can calculate the differences between calculated, estimated and measured values.

This feedback can provide insight on how the business plan, the gap analysis and the implementation was performed and will allow to control the processes

Providing this feedback to owners, operators and maintainers will allow them to make adjustments at the economical or physical level.

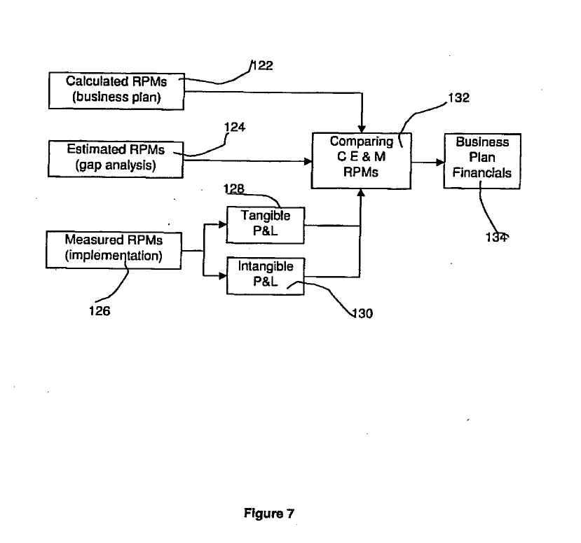

FIG. 7 shows calculated RPMs obtained during the business plan (122), estimated RPMs obtained during the gap analysis (124) compared (132) with the tangible measured RPMs from implementing RPM tasks (128). Measured RPMs (126) has an intangible component (I30) that can not be compared but can be listed as benefit.

Business plan financials (134), which is the final result from this feedback loop, can be compared with business plan financials (34) as improvements, resulting from the feedback process, on the way RPMs is measured are taken into consideration.

### 8) Developing a Methodology for Solving Complex Problems White Providing a ROI in a Short Amount of Time

### Problem:

There are no methodologies for solving complex problems such as those found in manufacturing plants.

It is an objective of this patent to simplify RPM

### Solution:

Solving problems in complex systems (those formed with a large number of components with different variables) have typically been approached from various angles or perspective.

Sometimes, various efforts provide results which are combined at some point. While this approach works, it tends to take longer and could create conflicts of interest.

Root cause analysis, a methodology commonly used to uncover problems in manufacturing, is applicable only when failure modes are known. This methodology doesn't lend well for systems in which the failures are unknown or poorly documented as is the case for manufacturing.

Finite Element (FE) method divides, identified and solves complex engineering problems and has applications in airplanes and building structures but doesn't lend well to problems with high human interaction.

FEMsm, service mark registration No. 6,584,191 to Sergio Rossi, defines FEM as engineering services involving the division of manufacturing into its macro and micro elements for applying continuous improvement processes to eliminate losses and increase profits immediately.

Neither FE or FEMsm, provide any ways to solve a complex problem and do not specify how to divide or how to solve. Fe does mention how to identify stress which is simple when dealing with engineering problems with little human interaction.

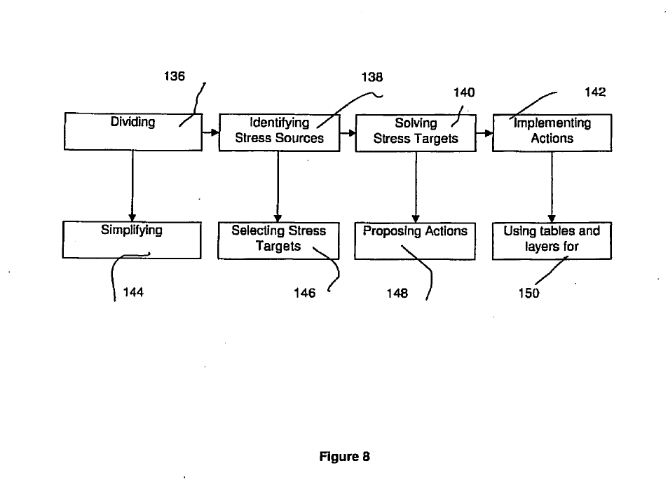

A methodology for providing prompt results that helps in keeping focus on main objectives while avoiding areas of conflicts is presented on FIG. 8.

FIG. 8 shows a process for solving complex systems with a large quantity of components with different variables.

FIG. 8 shows a method for dividing (136), identifying (138), solving stress targets (140) and implementing actions (142).

The purpose of dividing (136) a system into elements to gain a high level perspective of all the components of a system. These elements are further divided into macro, sub-macro, elements, micro and sub-micro.

Since the number of elements of complex systems can be rather large, it is important that we think in simplifying (144) the numbers of elements into groups that are related physically or functionally.

The first group is composed with essential elements which are those the system needs to perform its most critical functions. Without them, the system will not function.

Selecting essential elements for manufacturing could be made of the following: Human Performance, Processes, Machines, ROI and Data Management. Other essential elements could be simplified by functions: Engineering, Maintenance, Work Process & Leadership/management.

Identifying (138) elements that can cause stress (economical, physical, emotional, etc.) and thus called stress sources. Since we now have the system divided into elements we can identify stress sources at different areas of the system. For example, a stress source could be an owner who doesn't not believe in doing proper maintenance and runs machines until they fail. Identifying stress sources is not based on past failures as Root Cause Analysis is and does not need historical data which most of the times is flawed.

Selecting Stress Targets (146) is for turning identified stress sources into targets to be addressed. Using adjectives/verbs/functions to develop an opposite action aimed at reducing the stress source. For example, if miscommunications between production and maintenance is a stress source, then improving communications between production and maintenance is a corresponding stress target to be removed. Another example is when machine breakdowns is considered a stress source, then selecting to improve machinery reliability is the corresponding stress target.

Solving stress targets (140) is for proposing solutions to the stress targets (146) previously determined. Considering different solutions for addressing the stress targets (140) for solving stress sources (138) found. When solving stress targets (140) one must come up with solutions aimed at addressing the stress targets. For example, if production is wasting efficiencies, solving this problem (stress target) may require using Lean, known for removing waste instead of Six Sigma or Theory of Constraints (ToC) methodologies.

Proposing actions (148) is for presenting a list with solutions presented during the solving stress targets (140). Proposing actions/activities (148) to address the stress targets (146). For example, if ToC was one of the means for solving stress targets, the proposing action (148) is to find areas that impede or reduce the throughput of the system using elements from ToC.

Implementing actions or activities (142) is for implementing those selected activities from proposing actions (148). Implementing actions is when you select a solution for addressing stress targets (140) so that stress sources (138) are minimized, reduced or eliminated. In the previous example, if ToC was proposed as a possible solution for improving plant throughput, then during implementing actions (142) ToC process is implemented using the four components of ToC: 1) Identify constraints, 2) Exploit, 3) Subordinate and 4) Elevate constraint.

After dividing, identifying and before implementing actions, managing those activities is critical for providing prompt results which will translate into a faster ROI.

Since dividing system into elements, we can place them into groups or relevance. Using groups, levels or layers of elements place on tables for managing (150) we can direct information information adequately and specific to satisfy their interest. Since owners, operators and maintainers have different backgrounds and interests, it is important that information is directed aiming at their level of interests so that they can understand them and continue supporting.

For example, for a mechanic who just fixed a machine that was down, the details on how a machine was repaired is critical, for his manager knowing that the machine got fixed right is very important, for the operations manager knowing that his operators can go back to work and make product again is important and for the owners knowing that he will be able to deliver products to his final customer is important. The details on how the repair was done is not interesting for the owner. it is extremely important to share only the amount of information that each group/level/layer considers important and relevant so that each group/level/layer continues supporting and sustaining all improvement efforts. The leveling of information performed during the using tables or layers for managing (150) can be done using software.

Using tables/groups/levels/layers for managing (150) permits implementing actions/activities (142) in parallel and simultaneously. For example, while one group is doing vibration analysis, another group is training operators on how to lubricate a bearing while yet another group of managers is dividing maintenance tasks amongs operators and technicians. This layered approach permitted by this methodology produces more output in an organized manner everyone can follow to further generate a faster ROI which will gain owners support to sustain processes for improving manufacturing.

### 9) Building a Table for Managing/Troubleshooting Elements of a Complex Systems

When dealing with complex systems, it is very easy to get lost in the details, to lose sight on main objective. This causes mismanagement, delays, confusion and conflicts, all leading to a lower ROI.

It is an objective of this patent to provide a process for generating a table of elements to further simplify large systems with different variables.

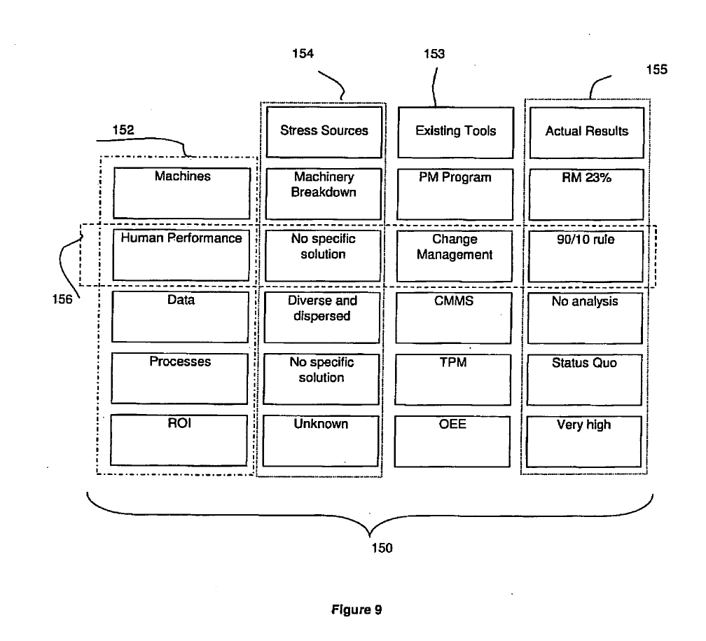

FIG. 9 shows how using a table of elements (150) to construct different groups-levels-layers for troubleshooting and analyzing purposes.

Using essential elements to fill the 1^{st} column. Using a second column for stress sources pertinent to each of the essential elements. For example, for the essential element machine, a key element of stress sources (154) is breakdowns as shown on the table (150).

Using a third column for analyzing existing tools (153) to see what is being used to reduce machinery breakdowns.

Once elements are determined to be essential, then that particular element can be put through the method for dividing (136), simplifying (144), identifying stress sources (138), selecting stress targets (146), solving stress targets (140), proposing actions (148), implementing actions (142) and using tables (150) for feeding back pertinent information to each level/group/layers.

Using tables (150) for managing allows us to implement the solutions selected faster and specific to those problems found to be the most important thus producing a faster ROI.

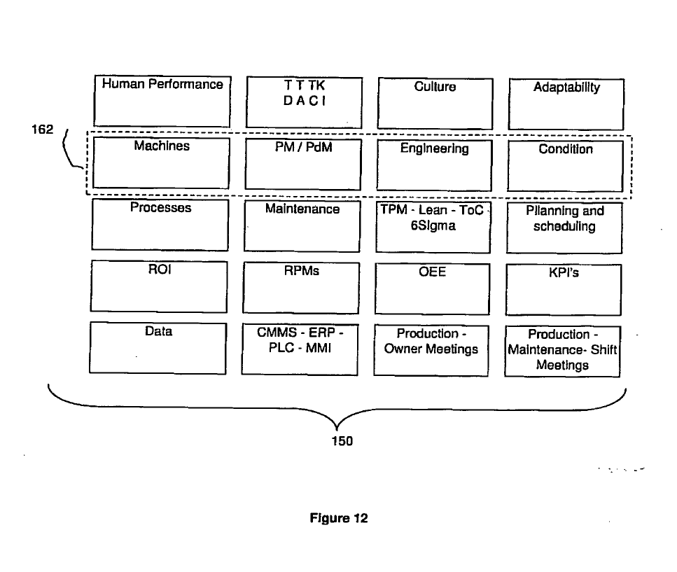

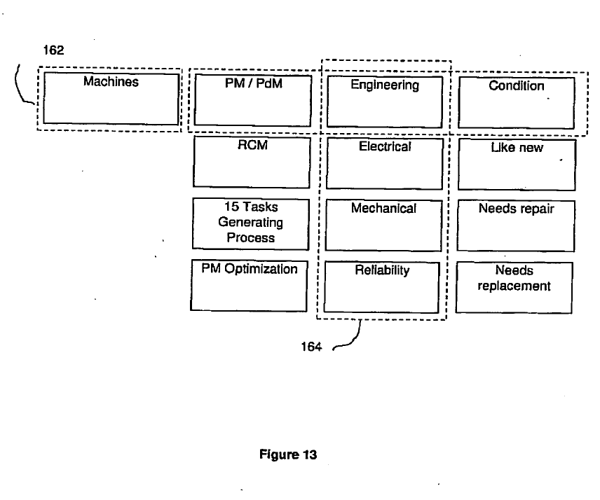

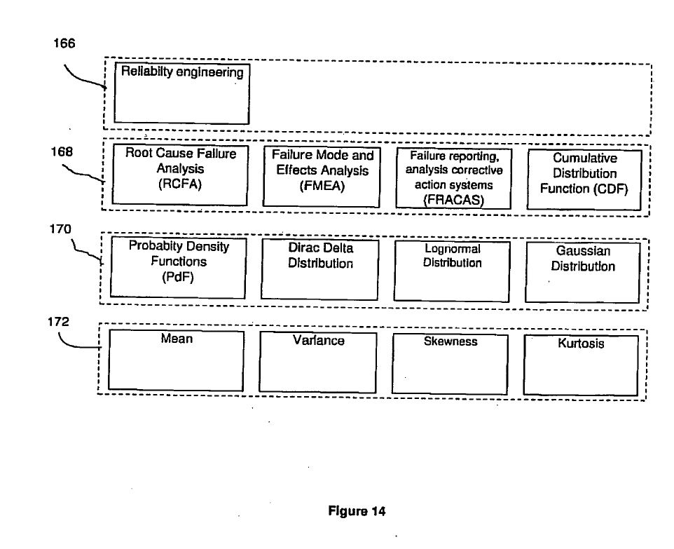

For example, during the asset plan, we realized that reliability processes had to be used to generate revenues because downtime was very high. Using our methodology we can further focus our efforts on a machine layer from a table. This machine layer is composed of PM/PdM, engineering and condition as shown on FIG. 12. When we further look into a deeper layer, we realized that Reliability engineering is one element of engineering as shown on FIG. 13. FIG. 14 shows Reliability engineering (166) uses several tools and selecting a (168) Cumulative Density Functions (CDF) for performing mathematical modeling on our complex systems. Selecting from this CDF The Gaussian distribution (170) because we feel that it will provide the closest approximation for the trend. A last layer (172) shows the characteristics that we must understand and use to define our density function

This methodology allow us to focus our efforts and investments into developing reliability engineering tools and not wasting efforts in, for example, improving the usage of a computerized maintenance management system (CMMS). The same analogy goes for troubleshooting and discovering stress sources for human performance, data management, processes and ROI.

FIG. 9 shows building a table of elements for a manufacturing system. Contained within area (152) are the essential macro elements for manufacturing: Machine, Human performance, Data management, Processes and ROI for dividing (136). Macro elements Stress Sources, Existing Tools and Actual Results are for simplifying (144) the system. Area (154) identifies stress sources (138) for each of the essential elements. The layer Human Performance is contained within (156) area. Area (155) shows results from using existing processes and methodologies further identifying stress targets (145). A table of elements can quickly show the areas in immediate need of attention while keeping in mind the high level perspective given by all macro elements as shown on FIG. 9.

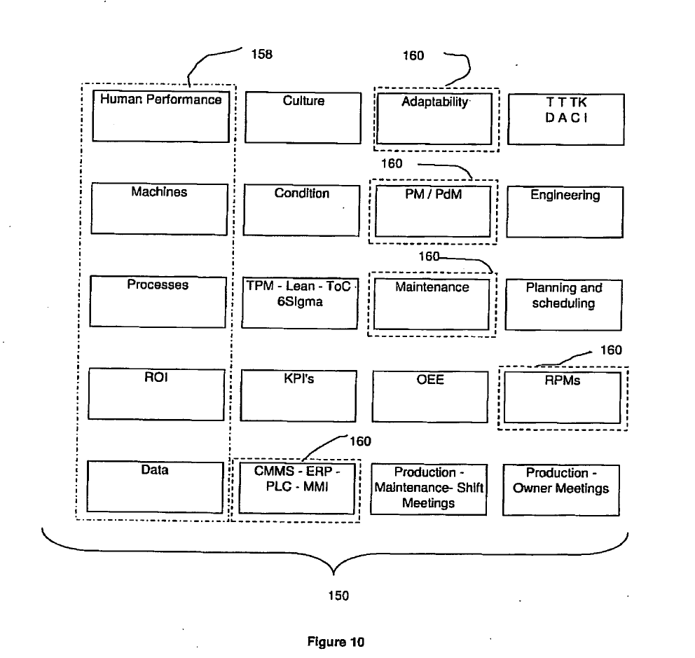

FIG. 10 shows a table of elements for a manufacturing system with key elements contained within dashed area (160) as in most need of improvement. Using a table of elements for approaching a complex system like the one shown allowing owners, operators and maintainers to improve processes using a parallel and simultaneous approach. For example, maintainers can work on PM/PdM while engineering works on CMMS implementation and operators implement a operator-based maintenance process.

This method can be used during a gap analysis or while implementing an improvement processes to produce a faster ROI. FIG. 10 shows Adaptability, PM/PdM, maintenance processes, RPMs and CMMS/ERP/PLC/MMI (all softwares) as areas in need of immediate improvement.

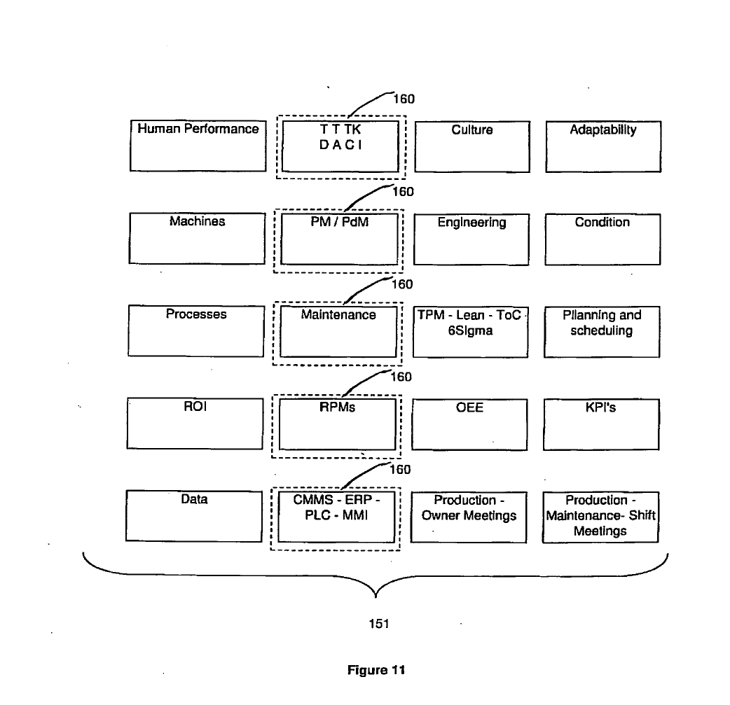

Those elements of a table can be identified with colors or numbers or by placing on first column indicating the severity of the losses pertaining to each element as shown on FIG. 11.

What is claimed is:

1) A process for improving manufacturing and asset maintenance
a) A process for generating a business plan for owners
b) A process for developing a Asset Plan for providing a ROI in a short amount of time
c) A process for developing a business plan for owners to improve RPM
d) A process for developing a business plan for Operators & Maintainers to improve RPM
e) A process for calculating a ROI from RPM activities
f) A process for providing a Feedback Loop for improving manufacturing and asset maintenance plan

2) A method for solving complex problems while providing a ROI in a short amount of time
a) A process for building a Table for Managing and troubleshooting Elements of a complex systems
b) A process for using a Table of elements for Identifying Sources of Stress
c) A process for developing a table of elements for prioritizing sources of stress
d) A process for developing Layers/Levels using a Table of Elements for Machines

3) software for entering, managing, trending and documenting reliability, performance and maintenance variables
